(19) United States
(12) Patent Application Publication
(10) Pub. No.: US 2018/0099366 A1
(43) Pub. Date: Apr. 12, 2018

(54) PNEUMATIC DRILLING DEVICE

(71) Applicant: Berry Metal Company, Harmony, PA (US)

(72) Inventor: Brayton Carner, Harmony, PA (US)

(73) Assignee: Berry Metal Company, Harmony, PA (US)

(21) Appl. No.: 15/633,344

(22) Filed: Jun. 26, 2017

Related U.S. Application Data
(60) Provisional application No. 62/354,141, filed on Jun. 24, 2016.

(51) Int. Cl. B23Q 5/033; B23B 45/04; E21B 44/06

(52) U.S. Cl. CPC B23Q 5/033; B25D 9/14; E21B 44/06; B23B 45/04

(57) ABSTRACT

A pneumatic drilling device comprising: an impact manifold or cylinder in fluid communication with a rotary air manifold or gear box; and a single air inlet. The single air inlet may be in fluid communication with the impact manifold or cylinder.

### CROSS REFERENCE TO RELATED APPLICATIONS

This application claims the benefit of provisional patent application U.S. Ser. No. 62/354,141 filed Jun. 24, 2016, which is incorporated by reference herein for all purposes.

### TECHNICAL FIELD OF THE INVENTION

The present disclosure generally relates to the field of pneumatic drilling devices. More precisely, the present invention concerns pneumatic drilling devices particularly adapted for drilling blast furnace tap holes.

BACKGROUND-FIELD OF THE DISCLOSURE

Conventional pneumatic drilling devices 10, such as for rock drilling, e.g., Ingersoll Rand VL-140, and as shown and described in U.S. Pat. Nos.: 4,084,646; 4,718,500 and 5,402,854 (all of which are incorporated by reference herein for all purposes). Such known pneumatic drilling devices, however, do not work well in the harsh environment of a blast furnace or other metal making furnace or vessel.

It would be advantageous to have a pneumatic drilling device that works well the harsh environment of a blast furnace or other metal making furnace or vessel.

### SUMMARY

Many other variations are possible with the present disclosure, and those and other teachings, variations, and advantages of the present disclosure will become apparent from the description and figures of the disclosure.

One aspect of a preferred embodiment of the present disclosure comprises a pneumatic drilling device comprising: an impact manifold or cylinder in fluid communication with a rotary air manifold or gear box; and a single air inlet.

In another aspect of a preferred pneumatic drilling device of the present disclosure, the single air inlet is in fluid communication with the impact manifold or cylinder.

In yet another aspect, a preferred pneumatic drilling device of the present disclosure further comprises a flushing tube made of metal.

In another aspect, a preferred pneumatic drilling device of the present disclosure further comprises no grease points.

In yet another aspect, a preferred pneumatic drilling device of the present disclosure further comprises one or more internal ports to allow an oil and air mixture introduced into the single air inlet to lubricate one or more internal parts of the pneumatic drilling device.

In another aspect, a preferred pneumatic drilling device of the present disclosure further comprises a heat shield.

In an additional aspect, a preferred pneumatic drilling device of the present disclosure further comprises a fixed exhaust that does not swivel.

### BRIEF DESCRIPTION OF THE SEVERAL VIEWS OF THE DRAWINGS

For the present disclosure to be easily understood and readily practiced, the present disclosure will now be described for purposes of illustration and not limitation in connection with the following figures, wherein:

FIG. 1 is a front perspective view of a conventional pneumatic drilling device;

FIG. 2 is a side perspective view of a preferred pneumatic drilling device of the present disclosure;

FIG. 3 is another perspective view of a preferred pneumatic drilling device of the present disclosure;

FIG. 4 is an rear perspective view of a preferred pneumatic drilling device of the present disclosure;

FIG. 5 is a perspective view of a purge air inlet of a conventional pneumatic drilling device;

FIG. 6 is a perspective view of a ported purge air inlet of a preferred pneumatic drilling device according to the present disclosure;

FIG. 7 is a top perspective view of a preferred pneumatic drilling device according to the present disclosure;

FIG. 8 is a side perspective view of a preferred pneumatic drilling device according to the present disclosure;

FIG. 9 is a side perspective view of a component of preferred pneumatic drilling device according to the present disclosure having metal alignment pins;

FIG. 10 is a side perspective view of a component of preferred pneumatic drilling device according to the present disclosure having a metal flushing tube;

FIG. 11 is a front perspective view of a cast face without an O-ring groove of a component of a conventional pneumatic drilling device;

FIG. 12 is a front perspective view of a cast face with O-ring groove of a component of preferred pneumatic drilling device according to the present disclosure;

FIG. 13 is a front perspective view of a conventional pneumatic drilling device showing grease points;

FIG. 14 is a front perspective view of a component and bearing lubricated via oil in compressed air mix in a preferred pneumatic drilling device according to the present disclosure;

FIG. 15 is a front perspective view of a gear box lubricated via oil in compressed air mix in a preferred pneumatic drilling device according to the present disclosure;

FIG. 16 is a front perspective view showing eliminated grease points in a preferred pneumatic drilling device according to the present disclosure;

FIG. 17 is a side perspective view of a heat shield installed on a preferred pneumatic drilling device according to the present disclosure;

FIG. 18 is a top side perspective view of a heat shield installed on a preferred pneumatic drilling device according to the present disclosure;

FIG. 19 is a top front perspective view of a preferred pneumatic drilling device according to the present disclosure employing acorn nuts and locking plates;

FIG. 20 is a top front perspective view of a conventional pneumatic drilling device employing standard hex nuts with exposed threads;

FIG. 21 is a top perspective view of a non-swiveling exhaust used in a preferred pneumatic drilling device according to the present disclosure and a swiveling exhaust employed by a conventional pneumatic drilling device;

FIG. 22 is a top side perspective view of a swiveling exhaust employed by a conventional pneumatic drilling device;

FIG. 23 is a top side perspective view of a fixed, non-swiveling exhaust used in a preferred pneumatic drilling device according to the present disclosure;

FIG. 24 is a top side perspective view of an adaptor mounting plate attached to a preferred pneumatic drilling device according to the present disclosure; and

FIG. 25 is a top rear perspective view of an adaptor mounting plate attached to a preferred pneumatic drilling device according to the present disclosure.

### DETAILED DESCRIPTION

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

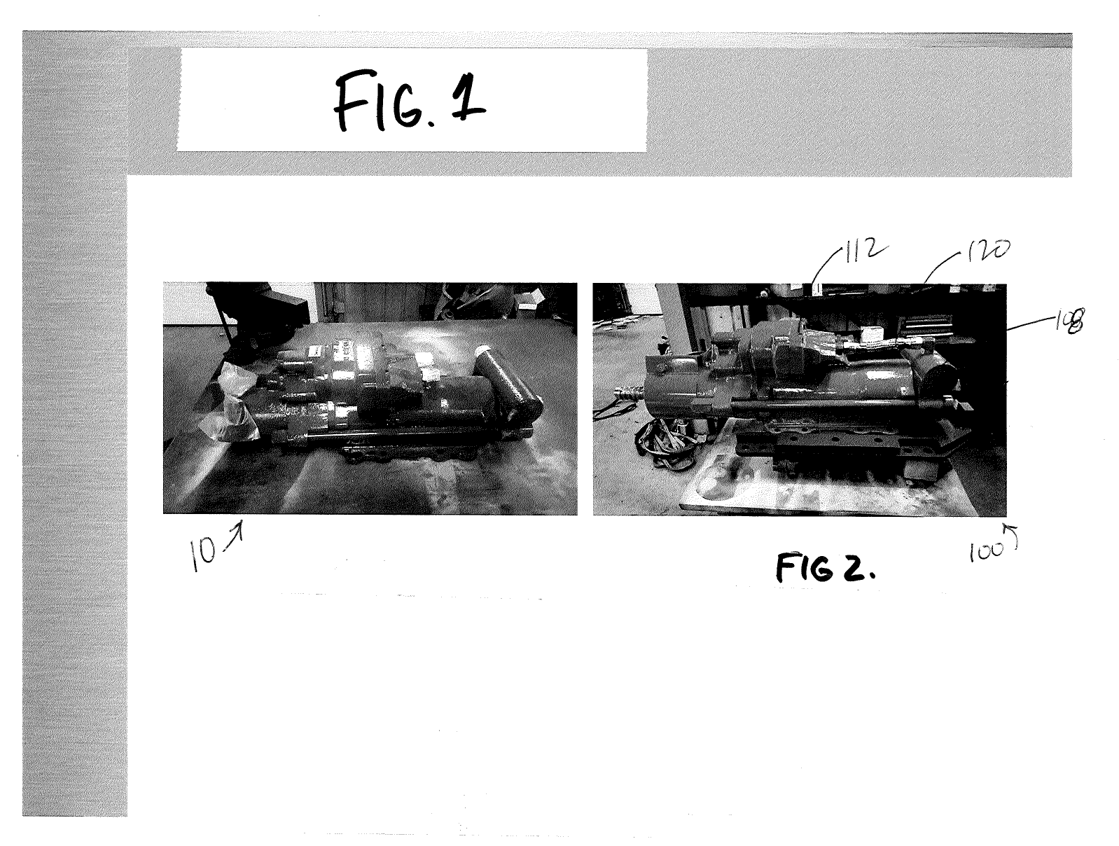

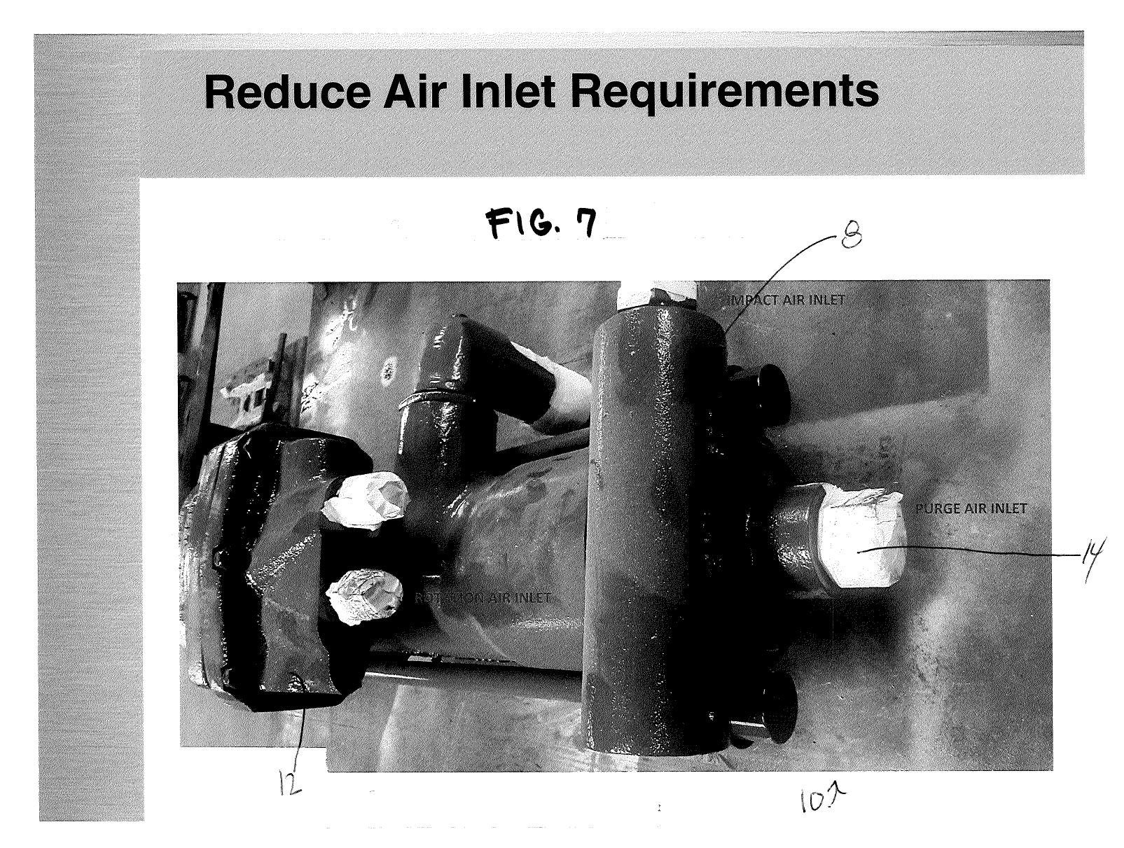

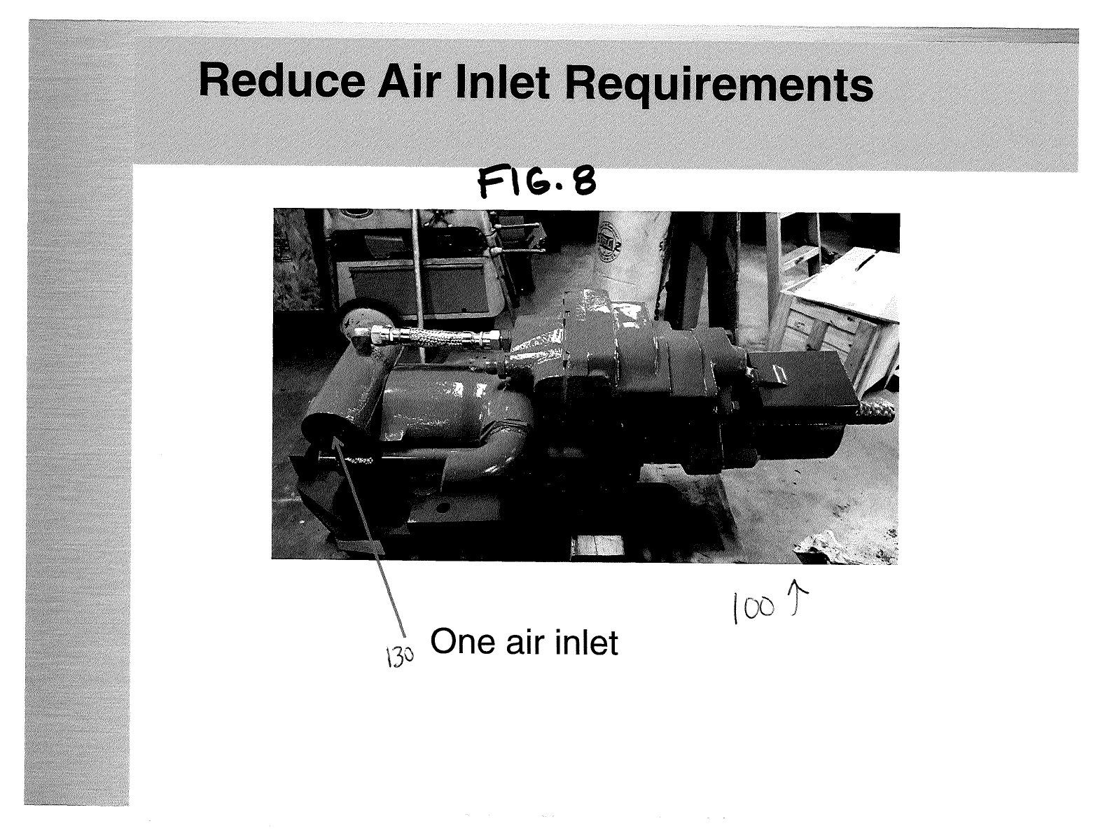

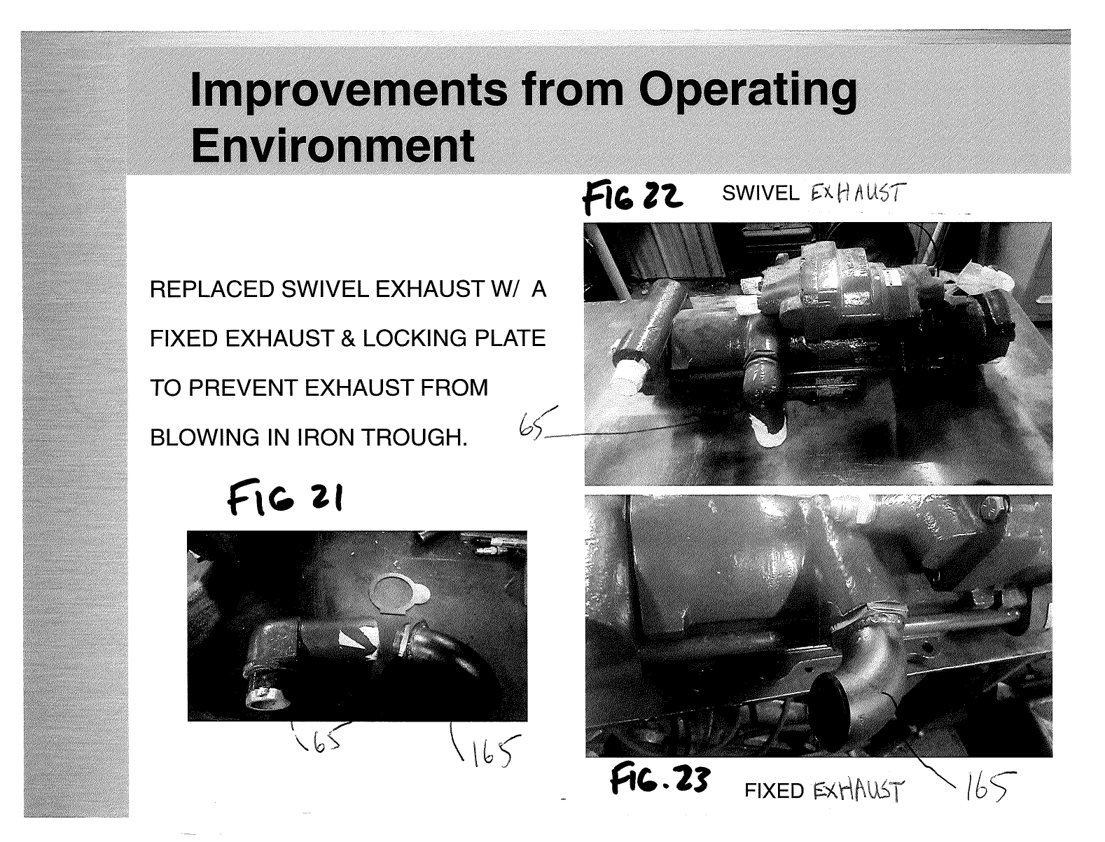

FIGS. 1, 5, 7, 11, 13, 20 and 22 show a conventional pneumatic drilling device 10, such as for rock drilling, e.g., Ingersoll Rand VL-140, as the basis for the modifications according to the present disclosure. Conventional drilling device 10 has a purge air inlet 14, an impact manifold/cylinder 8, and impact air inlet 7 and a rotation air inlet 13 to air rotation manifold/gear box 12.

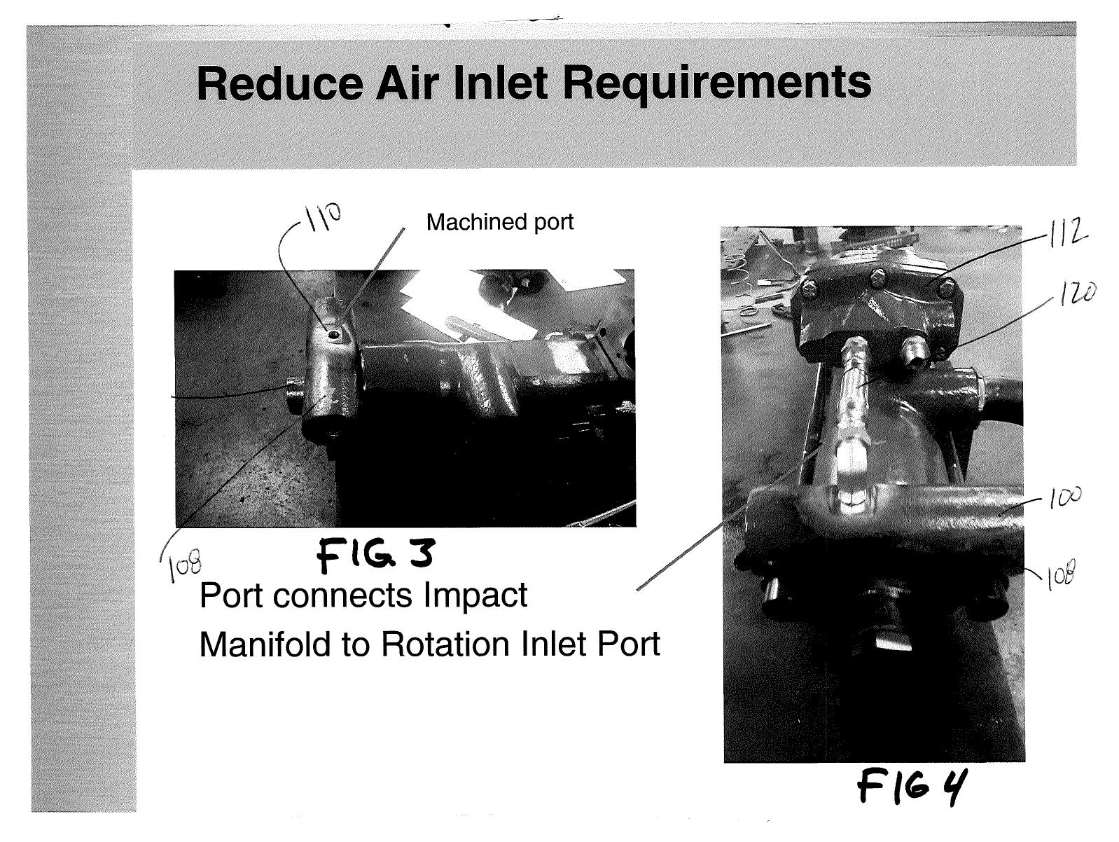

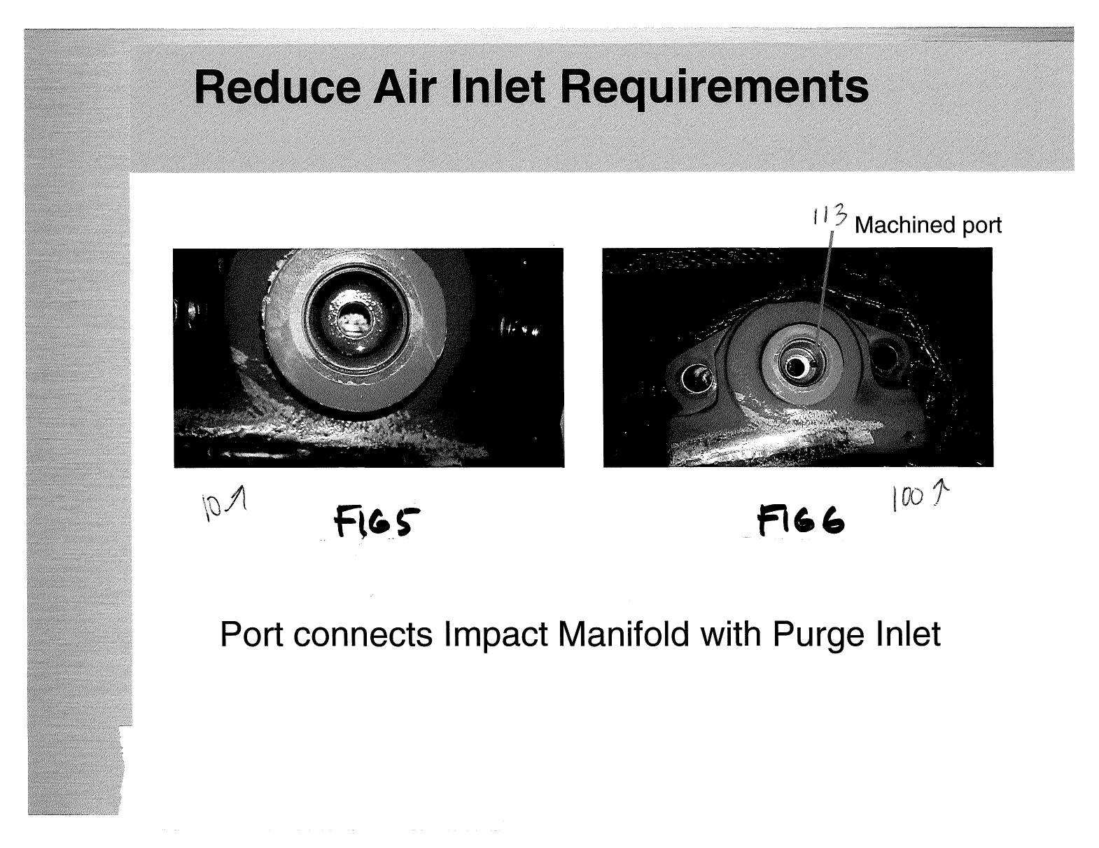

FIGS. 2-4, 6, 8-10, 12, 14, 16-19, 21, 23 and 24-5 show an improved pneumatic drilling device 100, for specifically adapted for use for drilling blast furnace tapholes. Pneumatic drilling device 100 comprises impact manifold/cylinder 108 connected to air rotation manifold/gearbox 112 for fluid communication by air connecting port 120. Air inlet 130 serves of the single compressed air inlet for the pneumatic drilling device 100, in place of the three air inlets of the conventional pneumatic drilling device 10, namely, impact air inlet 7, rotation air inlet 13 and purge air inlet 14. As shown in FIGS. 5 and 6, machined port 113 allows for fluid communication between impact manifold 108 and former purge air inlet 14 so that air from air inlet 130 may also be used as purge air in pneumatic drilling device 100.

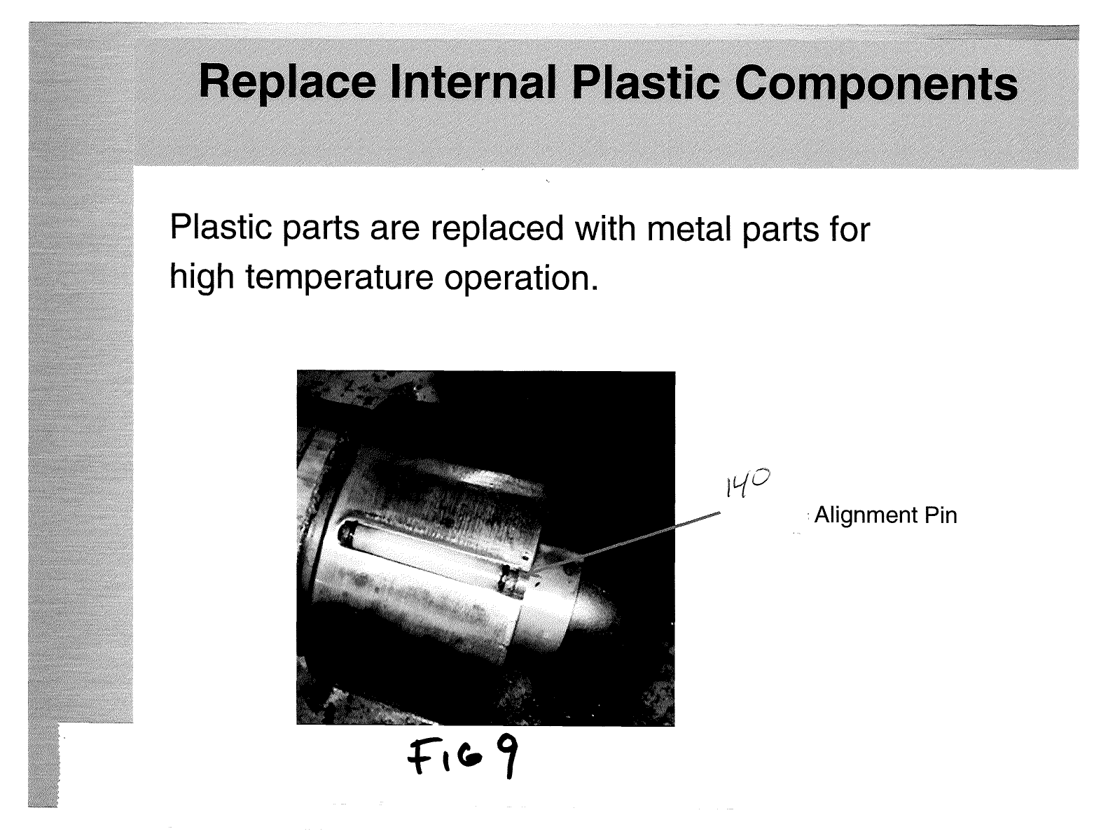

As shown in FIG. 9, alignment pins 140 are preferably made of metal for high temperature operation, as opposed to plastic alignment pins in the conventional pneumatic drilling device 10.

FIG. 10 shows an improved flushing tube 150 of pneumatic drilling device 100 made preferably from metal for improved durability in hot environments.

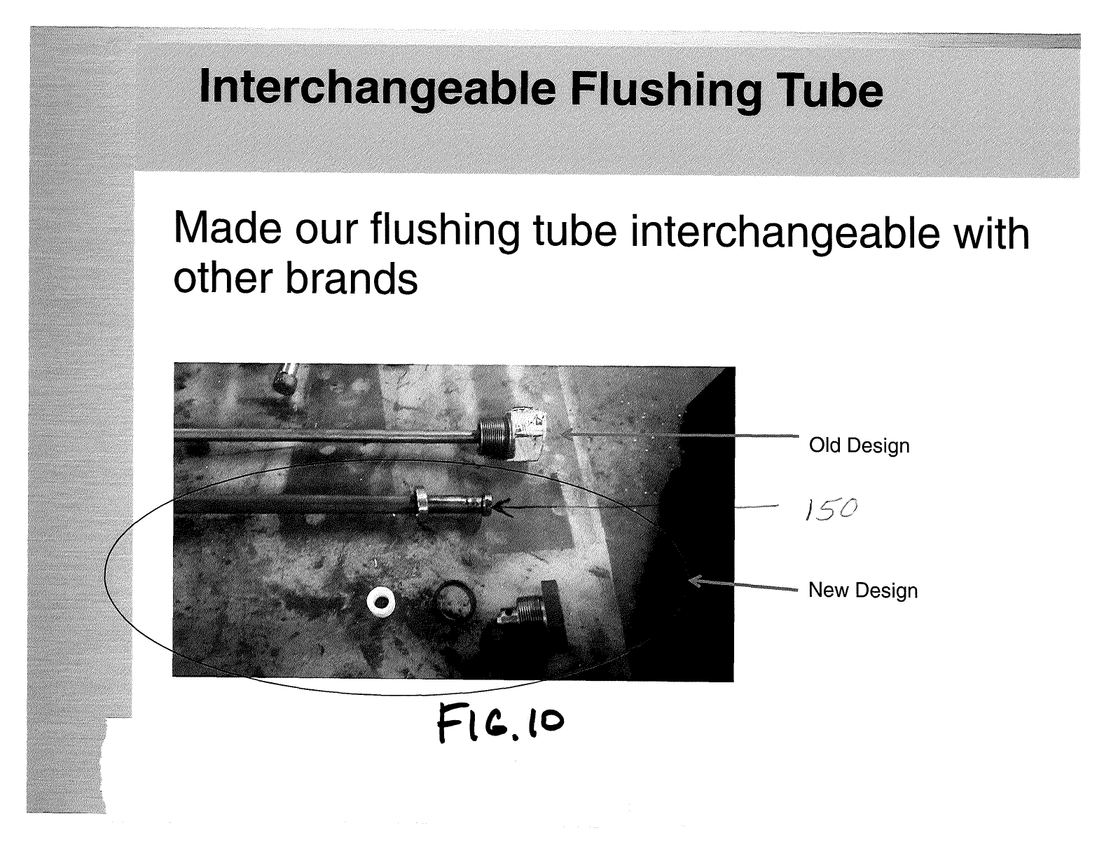

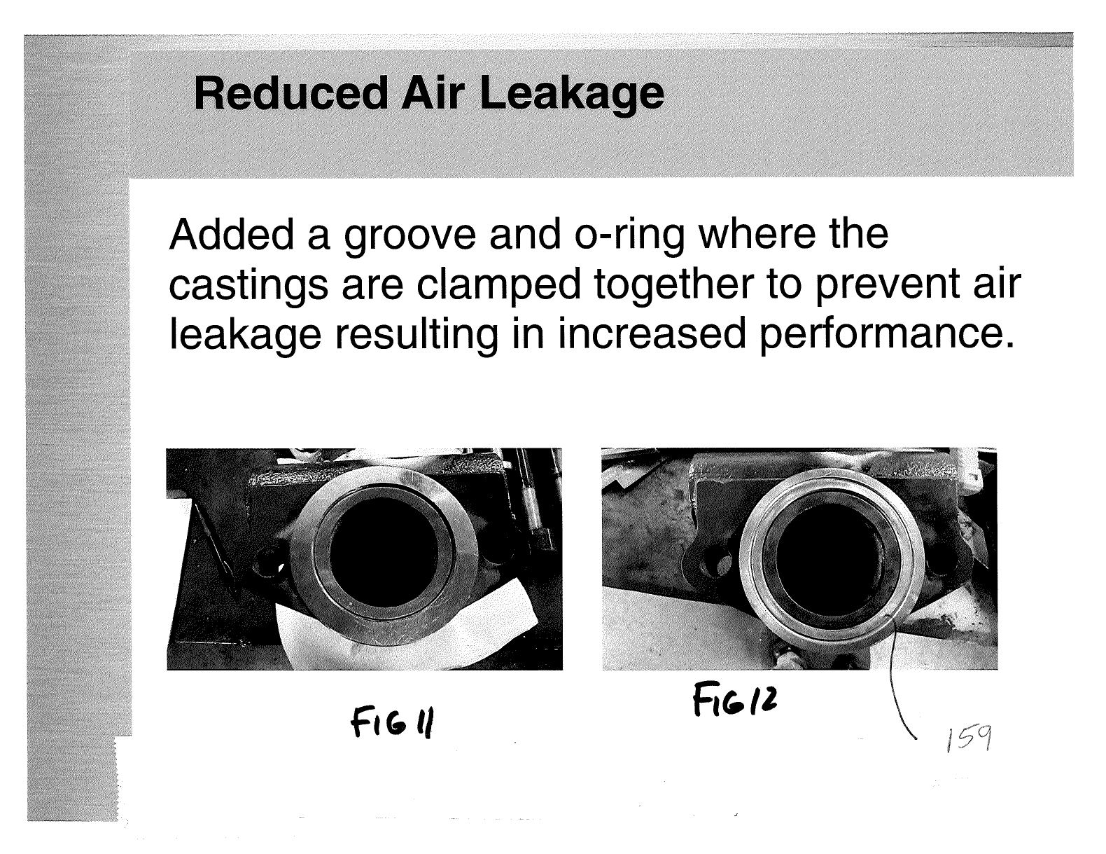

FIG. 12 shows an improved clamping design where castings of pneumatic drilling device 100 are clamped together having a groove 159 for receiving an O-ring to prevent air leakage resulting in better performance of pneumatic drilling device 100 versus clamping design of conventional drilling device 10 shown in FIG. 11.

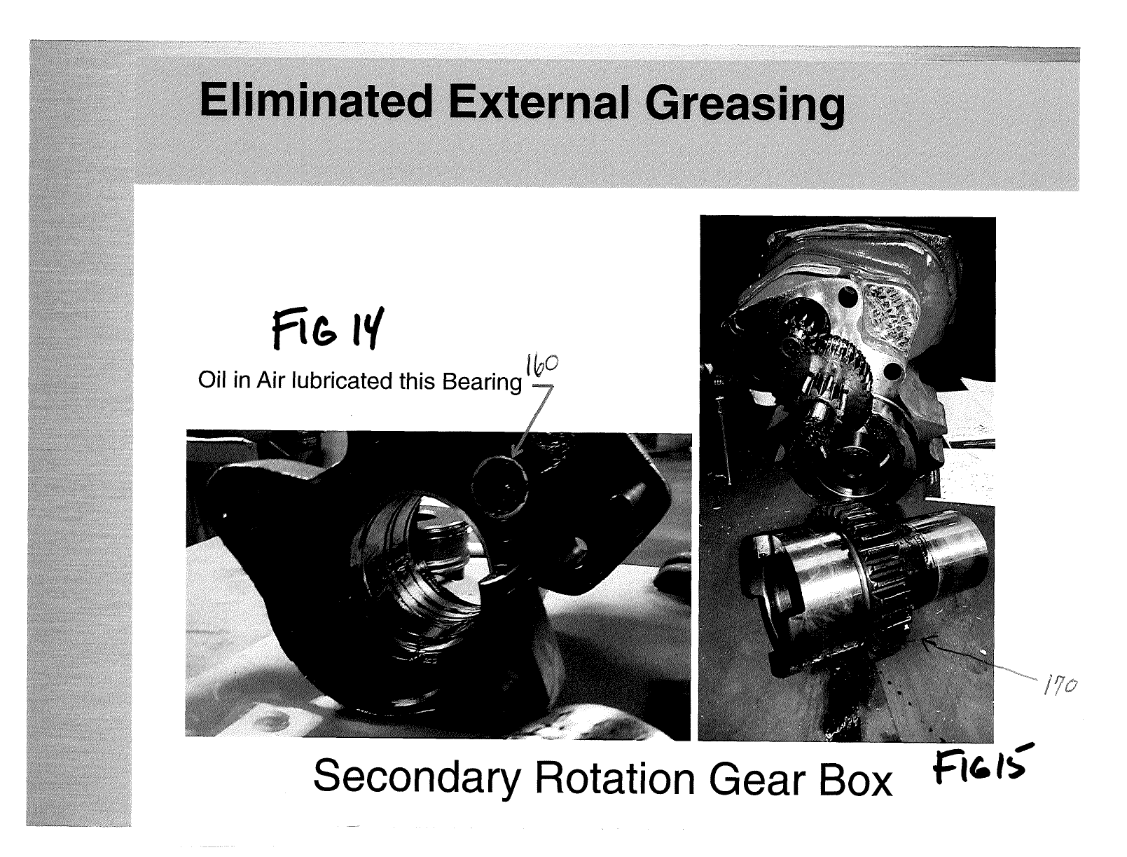

FIG. 13 shows grease points 20 and 22 of conventional pneumatic drilling device 10 that have been eliminated in the improved pneumatic drilling device 100. FIG. 16 shows eliminated grease points 130 and 132.

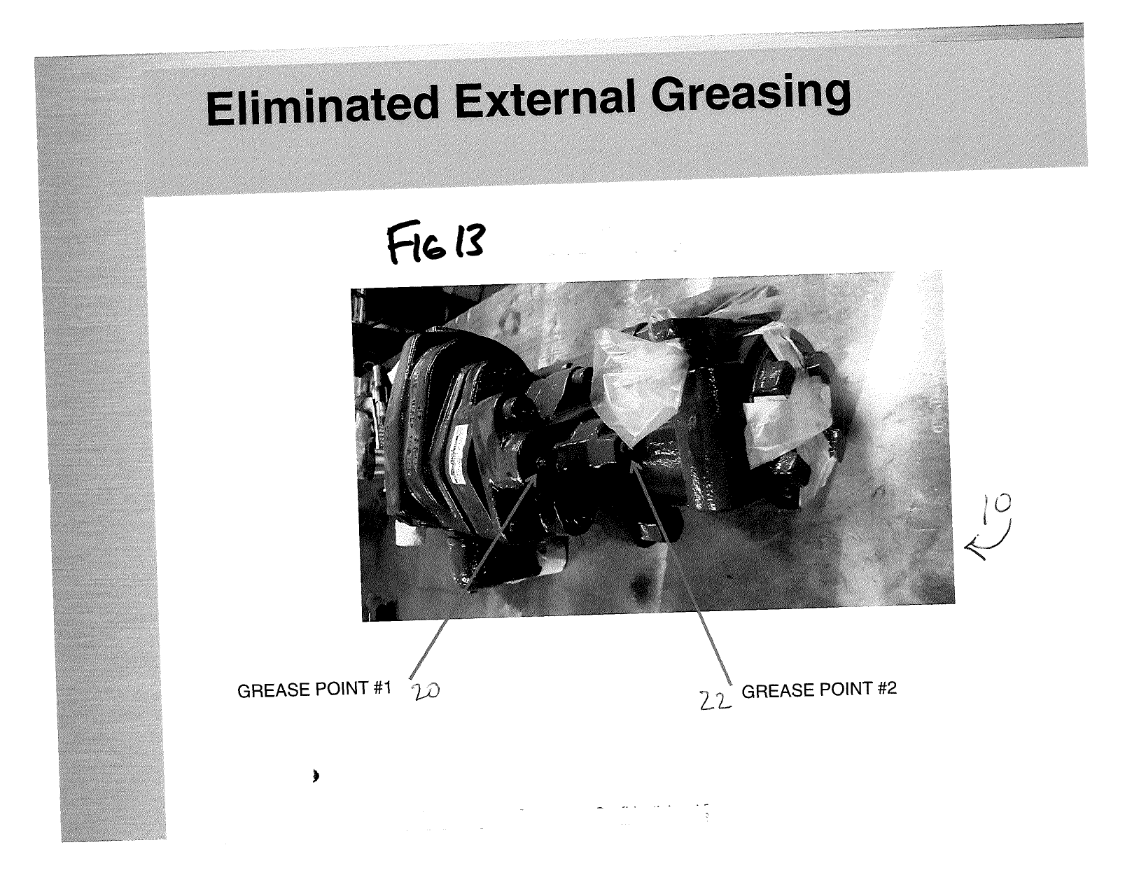

FIGS. 14 and 15 show bearing 160 and gear box 170 that can be lubricated by oil or lubricant spread throughout the improved pneumatic drilling device 100 via oil mixed in with compressed air used in the device 100. Port 113 also aids in this functionality.

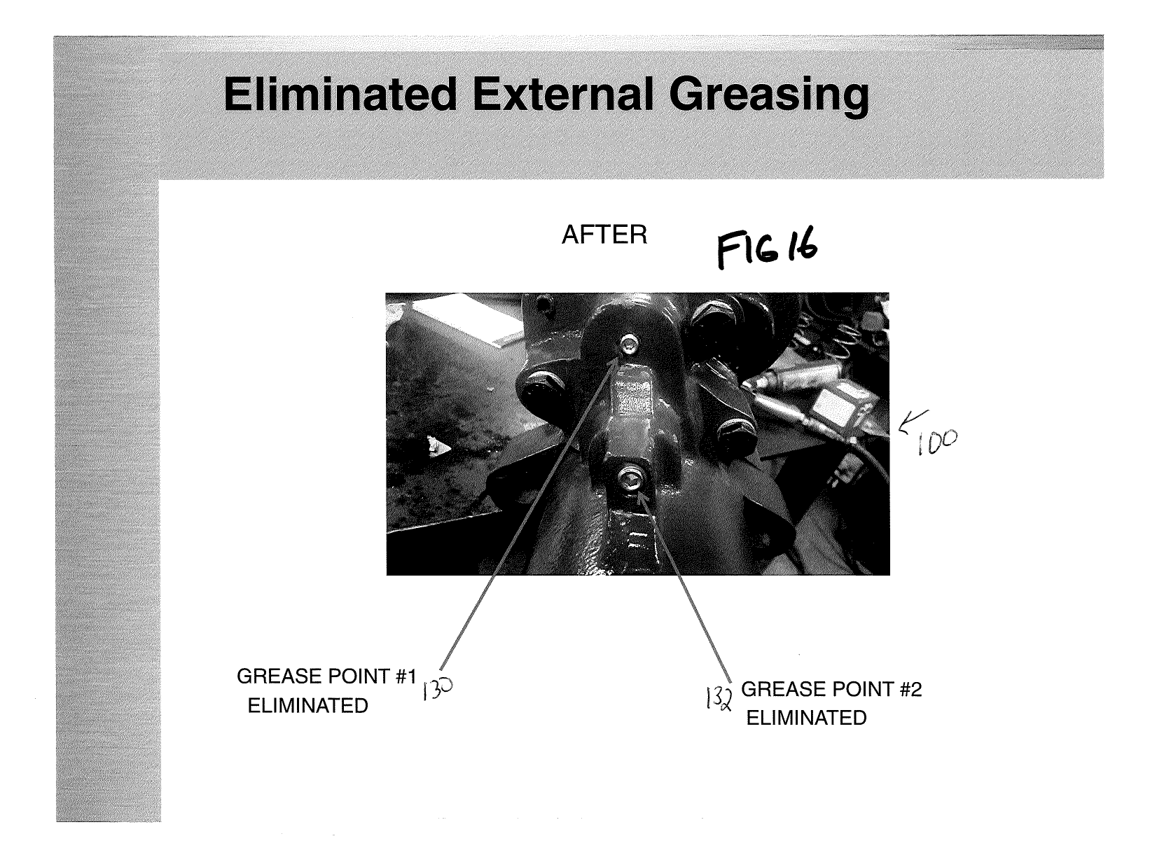

FIGS. 17 and 18 show front heat shield 180 added to the improved pneumatic drilling device 100 to protect against molten iron splash.

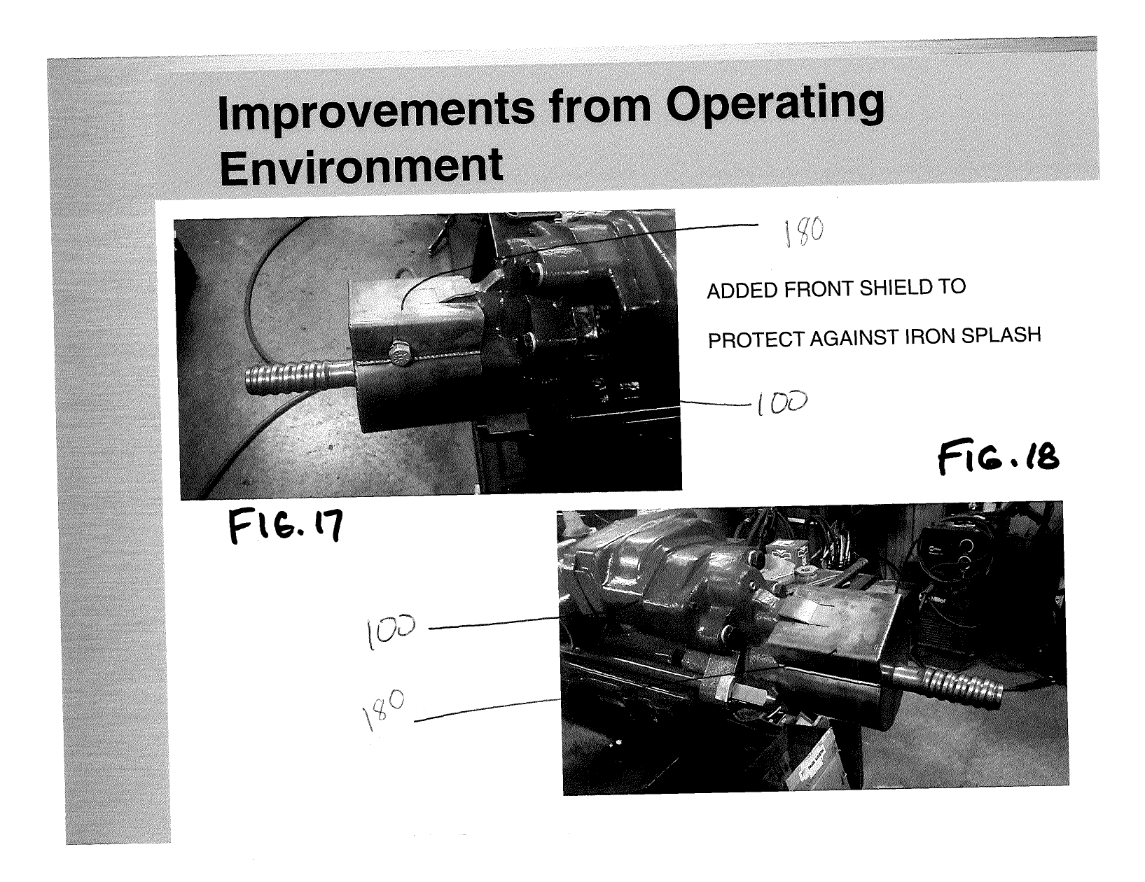

FIG. 19 shows the use of acorn nuts 160 and locking plates 162 to connect components to pneumatic drilling device 100 versus hex nuts 16 with exposed threads as shown in FIG. 20.

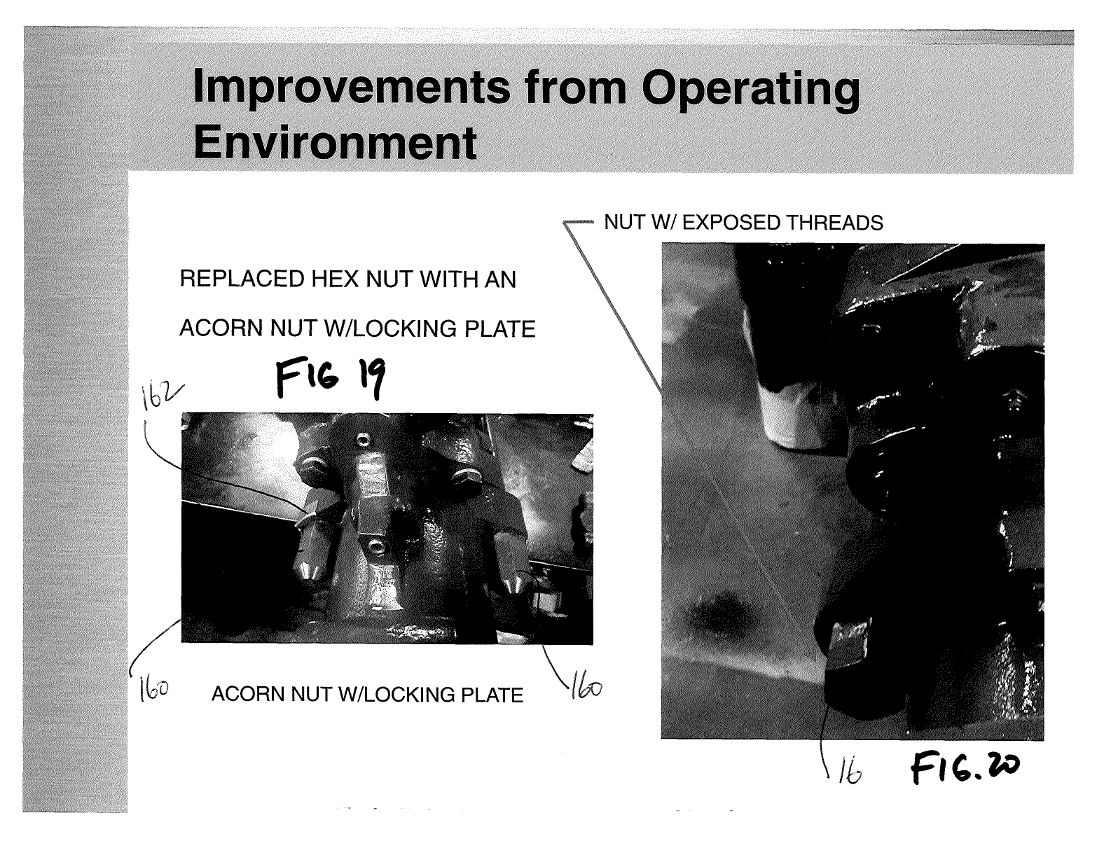

FIGS. 21-23 show the preferred use of a non-swiveling, fixed exhaust 165 in the improved pneumatic drilling device 100 instead of the swivel exhaust 65 in conventional pneumatic drilling device 10 to prevent exhaust from blowing in iron trough.

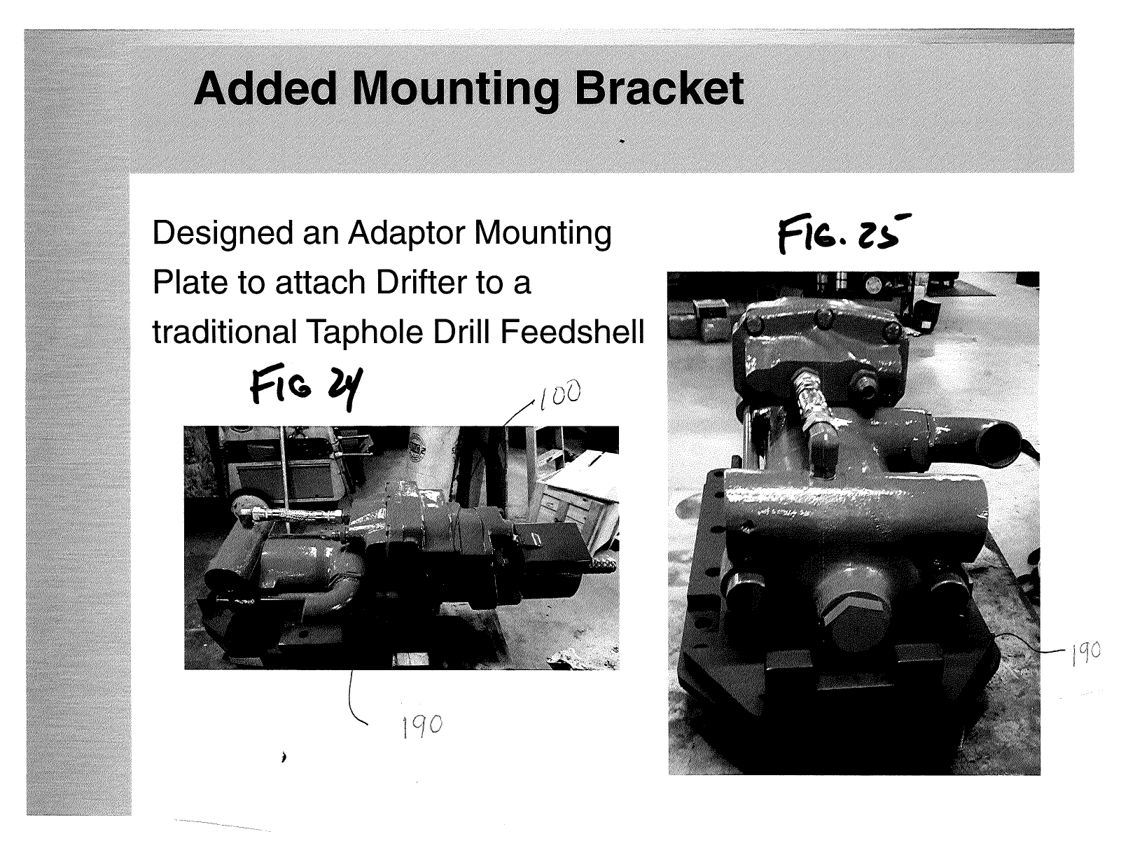

FIGS. 24-25 show a preferred adaptor mounting plate 190 for attaching the improved pneumatic drilling device 100 to a traditional taphole drill feedshell.

As described herein, design improvements and modification of the improved pneumatic drilling device 100 include: changed flushing tube design to be metal, in place of OEM plastic, for better durability when operating in a hot environment; added internal porting so drifter impact, rotation and purge air functions could all run of a single air supply (OEM design required three (3) air supplies); note: air supply can also be configured to run purge air independent of impact/rotation air; eliminated grease fittings and added internal porting to allow entire drill to be lubricated with oiled air thereby reducing the chances of getting dirt into the hammer internal components; changed internal distributor alignment pins to be steel, in place of OEM nylon material, for better durability when operating in a hot environment; increased OEM clearances between the piston, cylinder and bearing sleeve for better durability when operating in a hot environment; changed the design of the striking bar retainer locking bolt for more reliable torqueing of the bolt and to prevent loosening due to vibration; added heat shielding to protect the front housing of the drifter and provide protection from heat and iron/ slab splash; and replaced existing assembly rod nuts with acorn nuts to protect assembly rod threads from iron/slag splashing making it difficult to get the original nuts off the rod.

In the foregoing Detailed Description, various features are grouped together in a single embodiment to streamline the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A pneumatic drilling device comprising:
an impact manifold or cylinder in fluid communication with a rotary air manifold or gear box; and
a single air inlet.

2. The pneumatic drilling device of claim 1 wherein the single air inlet is in fluid communication with the impact manifold or cylinder.

3. The pneumatic drilling device of claim 1 further comprising a flushing tube made of metal.

4. The pneumatic drilling device of claim 1 further comprising no grease points.

5. The pneumatic drilling device of claim 1 further comprising one or more internal ports to allow an oil and air mixture introduced into the single air inlet to lubricate one or more internal parts of the pneumatic drilling device.

6. The pneumatic drilling device of claim 1 further comprising a heat shield.

7. The pneumatic drilling device of claim 1 further comprising a fixed exhaust that does not swivel.
